(19) United States
(12) Patent Application Publication
(10) Pub. No.: US 2013/0063690 A1
(43) Pub. Date: Mar. 14, 2013

(54) TUNABLE CHIRAL COMPOSITION, MULTI-COLOR LCD CONTAINING TUNABLE CHIRAL COMPOSITION AND METHOD FOR MAKING TUNABLE CHIRAL POLYMER

(71) Applicants: Hsien-Wei Chiang, Taipei City (TW); Chih-Yuan Wang, Taichung City (TW)

(72) Inventors: Hsien-Wei Chiang, Taipei City (TW); Chih-Yuan Wang, Taichung City (TW)

(21) Appl. No.: 13/605,962

(22) Filed: Sep. 6, 2012

(30) Foreign Application Priority Data
Sep. 9, 2011 (TW) 100132678

(51) Int. Cl. C09K 19/54; B01J 19/12; G02F 1/1343

(52) U.S. Cl. 349/139; 252/299.5; 204/157.15

(57) ABSTRACT

A tunable chiral composition includes a liquid crystal material, a tunable chiral material with at least one chiral center and at least one ethylenic double bond and a photo-initiator. The tunable chiral composition is substantially cross-linking agent free.

### BACKGROUND OF THE INVENTION

1. Field of the Invention

The present invention generally relates to a novel tunable chiral composition, a method for using the novel tunable chiral composition to form a tunable chiral polymer and a multicolor liquid crystal display containing such tunable chiral polymer. In particular, the present invention is directed to a tunable chiral composition which is free of a crosslinking agent to form a tunable chiral polymer under different exposure energies to reflect light of different wavelengths. The single tunable chiral composition of the present invention may form multicolor tunable chiral polymers and form one single layer multicolor liquid crystal display in order to reduce the works to cut the substrate and in order to have a better yield.

2. Description of the Prior Art

A cholesteric liquid crystal belongs to a group of reflective displays. The cholesteric liquid crystal is an environmentally-friendly material because it is very power-saving in use and ambient light is used to display the images in the absence of a backlight. One feature of the cholesteric liquid crystal resides in that the length of the pitch of the cholesteric liquid crystal is variable in accordance with the change of temperature so that it may selectively reflect light of different wavelengths to obtain different colors. Therefore, the colors of the cholesteric liquid crystal may be changeable by adding chiral agents of different pitches to rotate the pitch to adjust the reflection wavelengths and to obtain different colors such as red, green, blue to meet the demands of full color displays.

The traditional cholesteric liquid crystal color display technology uses three stacking monochrome cholesteric liquid crystal substrates such as red, green, and blue. The full-color results are achieved by switching different cholesteric liquid crystal substrates for different color reflection. The problems of this display technology are alignment challenge and high production cost when it comes to the problem of pixel alignment. Another solution is proposed (for example, Taiwanese Publication No. 200941073) but it is hard to cut the substrates properly.

U.S. Pat. No. 5,668,614 illustrates a tunable chiral composition in the embodiment 10, which contains a liquid crystal material and a cross-linked bisacrylate biphenyl (BAB) monomer serving as a tunable chiral material. Because the cross-linked bisacrylate biphenyl (BAB) is not readily obtainable by chemical synthesis or not readily commercial available, a new formulation of the tunable chiral composition is still needed.

### SUMMARY OF THE INVENTION

The present invention therefore proposes a novel tunable chiral composition, a method for forming a tunable chiral polymer by using this tunable chiral composition, and a multicolor liquid crystal display including the tunable chiral polymer. The tunable chiral composition of the present invention is in particular free of a cross-linking agent, and forms tunable chiral polymers which are capable of reflecting light of different wavelengths under different exposure energies. In other words, one single tunable chiral composition of the present invention can be converted into multicolor tunable chiral polymers, so one single layer of the tunable chiral composition forms a multicolor liquid crystal display, to reduce the times to cut the substrate and to improve the yield.

The present invention in a first aspect proposes a tunable chiral composition, including a liquid crystal material of 75-99 weight percent (wt.), 1-20 weight percent of a tunable chiral material containing at least one chiral center and at least one ethylenic double bond, and a photo-initiator of 0.05-5 weight percent. The tunable chiral composition of the present invention is substantially free of an ethylenic double bond cross-linking agent which has no chiral center.

In one embodiment of the present invention, the liquid crystal material may contain one or more liquid crystal monomers. For example, a liquid crystal monomer may be a nematic liquid crystal and/or a cholesteric liquid crystal. In another embodiment of the present invention, the tunable chiral material may have a binol moiety and/or may be an oligomer. The chiral center may be a tunable chiral center, for example, the chirality of the tunable chiral center may be tuned by the exposure to an illumination. In still another embodiment of the present invention, the photo-initiator may be a peroxide initiator, such as benzoyl peroxide and benzoyl superoxide, an azo compound initiators, such as azobisisobutyronitrile (AIBN), a redox initiators, an anionic initiators and a cationic initiators.

The present invention in a second aspect proposes a method for forming a tunable chiral polymer by using a tunable chiral composition in the presence of a suitable exposure condition. First, a tunable chiral composition is provided. The tunable chiral composition contains a liquid crystal material of 75-99 weight percent, a tunable chiral material of 1-20 weight percent and containing at least one chiral center and at least one ethylenic double bond, and a photo-initiator of 0.05-5 weight percent. Second, a first light energy is provided to initiate a first tunable chiral reaction in a first region, to change the tunable chiral material to obtain a first pitch. Then, a second light energy is provided to initiate a second tunable chiral reaction in a second region, to change the tunable chiral material to obtain a second pitch different form the first pitch. The first pitch and the second pitch may selectively reflect a first wavelength and a second wavelength respectively. The first wavelength and second wavelength may be one of red light, green light and blue light. The first region and the second region may be different.

In particular, the first pitch and the second pitch are mutually different. As a result, in the resultant tunable chiral polymer chains, it is not only substantially free of an ethylenic double bond cross-linking agent of no chiral center, but also light of different colors may be further combined to form a multi-color or a full color liquid crystal display.

The present invention further proposes a multi-color liquid crystal display, which includes a first electrode, a second electrode and a tunable chiral polymer. The tunable chiral polymer is disposed between the first electrode and second electrode, and has at least one a first polymeric status and a second polymeric status. The tunable chiral polymer includes a liquid crystal material of 75-90 weight percent, a tunable chiral material of 1-20 weight percent and including at least one chiral center and at least one ethylenic double bond, and a photo-initiator of 0.05-5 weight percent. The first polymeric status may selectively reflect a first wavelength, and the second polymeric status may selectively reflect a second wavelength different from the first wavelength. For example, a chiral dopant or different exposure conditions may be used to adjust the first wavelength and the second wavelength. The multi-color liquid crystal display of the present invention may further include a flow channel to accommodate the tunable chiral polymer.

In one embodiment of the present invention, the difference between the first polymeric status and the second polymeric state resides in the polymeric molecular weight. In another embodiment of the present invention, the first electrodes is transparent, and includes a conductive polymer material, such as at least one of indium tin oxide (ITO), indium zinc oxide (IZO), aluminum zinc oxide (AZO), zinc oxide (ZnO) and tin oxide (SnO). In still another embodiment of the present invention, the multi-color liquid crystal display further includes a first substrate for supporting the first electrode, and a second transparent substrate used to cover the second electrode. The first substrate and the second transparent substrate may respectively include at least one of glass, poly (ethylene terephthalate) (PET), polyether sulfone (PES) and polyimide (PI).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates the steps to form the tunable chiral polymer of the present invention.

FIG. 2 illustrates the components of the multi-color liquid crystal display of the present invention.

### DETAILED DESCRIPTION

The present invention provides a novel tunable chiral composition. The novel tunable chiral composition of the present invention in particular is cross-linking agent free. In addition, under different exposure energies, the novel tunable chiral composition of the present invention is also able to form tunable chiral polymers which reflect light of different wavelengths. The use of these tunable chiral polymers which are made from the tunable chiral composition and able to reflect light of different wavelengths polymer may form a multi-color liquid crystal display. One of the technical features of the present invention resides in the use of one single tunable chiral composition to convert to tunable chiral polymers which are able to reflect light of different wavelengths. Accordingly, one single layer of tunable chiral composition can be combined to obtain a multi-color liquid crystal display, so the times to cut the substrate can be reduced and the yield can be improved.

The present invention in a first aspect provides a tunable chiral composition. The tunable chiral composition of the present invention includes a liquid crystal material, a tunable chiral material and a photo-initiator. The tunable chiral composition of the present invention is substantially free of an ethylenic double bond cross-linking agent with no chiral center.

In the tunable chiral composition of the present invention, the liquid crystal material is usually 75-99 weight percent of the total tunable chiral composition. The liquid crystal material of the present invention may be a single liquid crystal monomer, or a liquid crystal composition made of a variety of different liquid crystal monomers. The liquid crystal material may be a nematic liquid crystal added to a chiral dopant such as E7, E48+CB15 from Merck. For example, a cholesteric liquid crystal, MLC-2150 or MDA-1788 from Merck.

The tunable chiral material of the present invention is usually 1-20 weight percent of the total tunable chiral composition, preferably 10%. The tunable chiral material of the present invention may include a binaphthalenyl groups, at least one of a tunable chiral center and at least one ethylenic double bond . . . etc. The ethylenic double bond group, the carboxyl group which undergoes the photo-decarboxylation reaction or molecules suitable for the tunable chiral material may refer to “Sur, S. K., and Colpa, J P, 1989, Spectrosc Lett., 22, 965.”

The characteristics of the tunable chiral material are that it may change its chirality under appropriate exposure conditions. In other words, through the illumination it changes the chirality of the chiral center, for example, becomes an achiral compounds, or a racemic mixture. Therefore, these tunable chiral materials have at least one tunable chiral center, and undergo a photochemical reaction under an appropriate exposure. These tunable chiral materials may be a polymeric monomer, such as (S)-(-)-2-hydroxy-2′-[4′-(v-acryl-ylundecyloxy)biphenyl-4-carboxy]-1,1′-bi naphthalene. For example, some organic carboxyl molecules are known to undergo the photo-decarboxylation reaction under an appropriate exposure condition to eliminate the carboxyl group to become an achiral compound.

Because the tunable chiral materials of the present invention undergo a polymerization reaction in an appropriate initial condition, therefore the tunable chiral materials of the present invention may include at least one ethylenic bond (an active double bond). The namely ethylenic bond means an active chemical bond which undergoes a polymerization reaction in an appropriate initiative condition. The ethylenic bond may be a propenyl group or a meth-propenyl group of single functional group, double functional groups or multiple functional groups.

In the tunable chiral composition of the present invention there maybe a small amount of a photo-initiator, for example, 0.05-5 weight percent of the total tunable chiral composition, preferably 5,000 ppm. Under an appropriate exposure condition, the photo-initiator will initiate the polymeric reaction of the tunable chiral materials to form polymer chains of appropriate molecular weights, to serve as the template for inducing the liquid crystal materials to have appropriate pitch.

The photo-initiator of the present invention may be various appropriate photo-initiators. For example, it can be a peroxide initiator, such as benzoyl peroxide and benzoyl superoxide, an azo compound initiators, such as azo-bis-isobutyronitrile (AIBN), a redox initiators, an anionic initiators or a cationic initiators. Different photo-initiators are subject to the responses of different exposure conditions.

The present invention recommends using different exposure conditions, such as different exposure energies, exposure wavelengths and/or exposure time, so that the photo-initiator(s) may trigger the same tunable chiral materials to undergo polymeric reactions of different degrees, and further to obtain polymeric chains of different molecular weights. Polymeric chains of different molecular weights may further induce liquid crystal materials to have different pitches. Different pitches are capable of selectively reflecting light of different wavelengths, while making the same tunable chiral material produce different colors after combination.

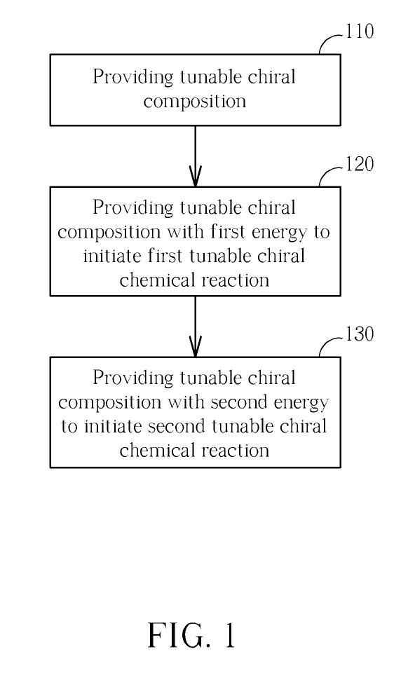

As described above, because of the use of different exposure conditions, the same tunable chiral material yields polymer chains of different molecular weight, the present invention accordingly provides a method to form a tunable chiral polymer by using a tunable chiral composition under appropriate exposure conditions. FIG. 1 illustrates the steps to form the tunable chiral polymer of the present invention.

First, please refer to FIG. 1, a tunable chiral composition is provided. Please refer to the above descriptions for the suitable tunable chiral compositions. Second, the tunable chiral composition is provided with a first energy to initiate a first tunable chiral chemical reaction 120. The first tunable chiral chemical reaction 120 changes the results of the polymeric reaction of the tunable chiral materials in some regions so that a liquid crystal material yields a first pitch which selectively reflects a first wavelength under the influence of the tunable chiral materials. For example, the first tunable chiral chemical reaction 120 may be initiated by UV light at an appropriate dose.

When the first tunable chiral chemical reaction 120 is carried out, a mask may be optionally used to keep some tunable chiral compositions from illumination to define the needed regions to reflect light of a determined color, such as visible light of red, orange, yellow, green, blue, indigo, purple . . . etc. As a result, regions other than these will not undergo the first tunable chiral chemical reaction. The first energy used in the first tunable chiral chemical reaction is usually smaller than the second energy to produce a first pitch smaller than a second pitch. For example, if a first pitch which reflects green light is needed, exposure energies, exposure wavelengths and/or exposure time of the first energy may be adjusted, so as to obtain the first pitch by a lower dose.

Then, the tunable chiral compositions are provided with a second energy, to initiate a second tunable chiral chemical reaction 130. The second tunable chiral chemical reaction 130 also changes the results of the polymeric reaction of the tunable chiral materials in some regions so that a liquid crystal material yields a second pitch which selectively reflects a second wavelength under the influence of the tunable chiral materials to obtain another color, such as red, orange, yellow, green, blue, indigo, or purple. For example, the second tunable chiral chemical reaction 130 may be initiated by UV light at an appropriate dose.

A mask may be optionally used to keep some regions from the second tunable chiral chemical reaction 130. The second tunable chiral chemical reaction 130 makes the first pitch different from the second pitch. Preferably, the second pitch is greater than the first pitch.

For example, if a second pitch which reflects red light is needed, exposure energies, exposure wavelengths and/or exposure time of the second energy may be adjusted, so as to obtain the needed second pitch. Since the above described procedures obtain different pitches by using different energies in different regions of the same tunable chiral compositions, the method of the present invention accordingly is capable of obtaining a multi-color liquid crystal which has various regions reflecting different colors from a same tunable chiral material.

Because the tunable chiral compositions of the present invention is substantially free of an ethylenic double bond cross-linking agent which has no chiral center, the resultant tunable chiral polymeric chains accordingly consists essentially of one or more tunable chiral materials, or further of its derivative which has changed chiral center. However, the tunable chiral polymer of the present invention is substantially free of an irrelevant ethylenic double bond cross-linking agent which has no chiral center.

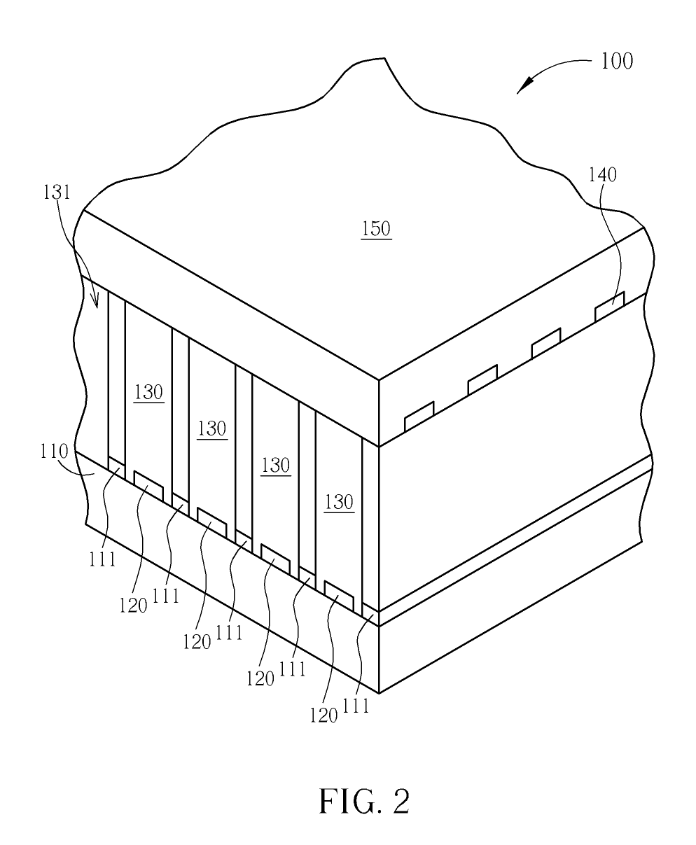

The present invention further provides a multi-color liquid crystal display, which has a tunable chiral polymer which has one single layer and shows at least two different pitches. FIG. 2 illustrates the components of the multi-color liquid crystal display of the present invention. Please refer to FIG. 2, the multi-color liquid crystal display 100 of the present invention includes a first substrate 110, a first electrode 120, a tunable chiral polymer 130, a second electrode 140 and a second substrate 150. The first substrate 110 is used to support the first electrode 120, the tunable chiral polymer 130, the second electrode 140 and the second substrate 150. The materials of the first substrate 110 may be at least one of glass, polyethylene terephthalate (PET), polyethersulfone (PES) and polyimide (PI). Preferably, the materials for the first substrate 110 are not light-reflective. The first electrode 120 may include any appropriate conductive material such as indium tin oxide (ITO), indium zinc oxide (IZO), aluminum zinc oxide of (AZO), zinc oxide (ZnO), tin oxide (SnO) . . . etc. Preferably, the materials for the first electrode 120 are not light-reflective, either. In addition, the first electrode 120 and the second electrode 140 may form a matrix, or they may be arranged in a vertical direction with each other.

The second electrode 140 and the second substrate 150 together cover the first substrate 110, the first electrode 120 and the tunable chiral polymer 130 so the second electrode 140 and the second substrate 150 both are transparent. For example, the second electrode 140 may include a conductive polymer material, or a conductive material such as indium tin oxide (ITO), indium zinc oxide (IZO), aluminum zinc (AZO), zinc oxide (ZnO), tin oxide (SnO) . . . etc. On the other hand, the second substrate 150 may include a transparent material such as glass, polyethylene terephthalate (PET), polyethersulfone (PES) and polyimide (PI) . . . etc.

In one embodiment of the present invention, the substrate may further include a flow channel for accommodating the tunable chiral polymer 130. For example, the second substrate 150 includes a flow channel 131 which accommodates the tunable chiral polymer 130, to facilitate the tunable chiral composition 130 of the present invention 130 to uniformly flow in. In addition, optionally the first substrate 110 may include an adhesive layer 111, for fixing the flow channel 131, the first substrate 110 and the second substrate 150. Or alternatively, the adhesive layer 111 may be used to form the flow channel 131.

The tunable chiral polymer 130 is disposed between the first electrode 120 and the second electrode 140, to form a single layer structure. The tunable chiral polymer 130 of the present invention which is located indifferent regions may have at least two different polymeric states, and different pitches which correspond to the different polymeric states. For example, the tunable chiral polymer 130 of the present invention has a first polymeric state and a second polymeric state, or further has a third polymeric state which is different to both the first polymeric state and the second polymeric state.

The tunable chiral polymer 130 includes a liquid crystal material of 75-99 weight percent, a tunable chiral material of 1-20 weight percent, and a photo-initiator of 0.05-5 weight percent. Please refer to the above descriptions for the details of the liquid crystal material, the tunable chiral material as well as the photo-initiator.

The first polymeric state selectively reflects a first wavelength, the second polymeric state selectively reflects a second wavelength different from the first wavelength, and the third polymeric state selectively reflects a third wavelength different from both the first wavelength and the second wavelength. As a result, in a same multi-color liquid crystal display 100 red light, green light and blue light are available at the same time. For example, a chiral dopant or different exposure conditions may be used to adjust the first pitch, the second pitch and the third pitch to obtain mutually different a first wavelength, a second wavelength and a third wavelength. The suitable chiral dopant may be CB15, CE1 or R1011.

TABLE 1

| | Liquid | Tunable | | Cross- | UV | |
|---|---|---|---|---|---|---|
| | Crystal | Chiral | Photo- | linking | Energy | |
| | Material | Material | initiator | Agent | J/cm² | Color |
| Example 1 | A | B | C | — | — | blue |
| Example 2 | A | B | C | — | 30 | green |
| Example 3 | A | B | C | — | 120 | red |
| Comparative | D | E | — | F | | blue |
| example 1 | | | | | | |
| Comparative | D | E | — | F | 60 | green |
| example 2 | | | | | | |
| Comparative | D | E | — | F | 220 | red |
| example 3 | | | | | | |

Remarks:
UV-RADCOL is used to measure the energy of the UV light.
1. Liquid crystal material A: MLC-2150 (1.3266 g) + MLC-2142 (0.6136 g) from Merck
2. Tunable chiral material B: TCM 1 (S)-(−)-2-hydroxy-2′-[4′-(w-pentylloxy)biphenyl-4-carboxy]-1,1′-binaphthalene) 0.27 g
3. Photo-initiator C: (2,2-dimethoxy-2-phenylacetophenone) 0.02 g
4. Liquid crystal material D: MLC-2150 (1.3866 g) + MLC-2142 (0.6106 g) from Merck
5. Tunable chiral material E: TCM 1 (0.11 g) (S)-(−)-2-hydroxy-2-[4′-(w-pentylloxy)biphenyl-4-carboxy]-1,1′-binaphthalene
6. Cross-linking Agent F: bisacrylate biphenyl 0.02 g.

Table 1 shows the resultant tunable chiral polymers of different colors obtained by replacing the cross-linking agent with the photo-initiator in the present invention. As the crosslinking agent F (bisacrylate biphenyl) is not only not readily available by chemical synthesis but also intrinsically dangerous, the present invention uses cheap photo-initiator to replace the cross-linking agent to be advantageous in manufacturing-cost. In addition, the tunable chiral polymers of the present invention are substantially free of crosslinking agent accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A tunable chiral composition, comprising:
a liquid crystal material of 75 wt. %-99 wt. %;
a tunable chiral material of 1 wt. %-20 wt. % comprising at least one chiral center and at least one ethylenic double bond; and
a photo-initiator of 0.05 wt. %-5 wt. %.

2. The tunable chiral composition of claim 1, wherein said liquid crystal material comprises a nematic liquid crystal and a cholesteric liquid crystal.

3. The tunable chiral composition of claim 1, wherein said chiral center is a tunable chiral center.

4. The tunable chiral composition of claim 1, wherein said tunable chiral material comprises an oligomer.

5. The tunable chiral composition of claim 1, wherein said tunable chiral material comprises a bisnaphthol group.

6. The tunable chiral composition of claim 1, wherein said photo-initiator is selected from a group consisting of a peroxide initiator, an azo compound initiator, a redox initiator, an anionic initiator and a cationic initiator.

7. The tunable chiral composition of claim 6, wherein said peroxide initiator comprises at least one of benzoyl peroxide and benzoyl superoxide.

8. The tunable chiral composition of claim 6, wherein said azo compound initiator comprises azobisisobutyronitrile (AIBN).

9. The tunable chiral composition of claim 1, wherein said tunable chiral composition is substantially free of a crosslinking agent.

10. A method for forming a tunable chiral polymer, comprising:
providing a tunable chiral composition, comprising:
a liquid crystal material of 75 wt. %-99 wt. %;
a tunable chiral material of 1 wt. %-20 wt. % comprising at least one chiral center and at least one ethylenic double bond; and
a photo-initiator of 0.05 wt. %-5 wt. %;
providing a first optical energy to initiate a first tunable chiral reaction and to change said tunable chiral composition to obtain a first pitch; and
providing a second optical energy to initiate a second tunable chiral reaction and to change said tunable chiral composition to obtain a second pitch, wherein said first pitch is different from said second pitch.

11. A multicolor liquid crystal display, comprising:
a first electrode;
a second electrode; and
a tunable chiral polymer disposed between said first electrode and said second electrode and comprising a first polymeric state and a second polymeric state, wherein said tunable chiral polymer comprises:
a liquid crystal material of 75 wt. %-99 wt. %;
a tunable chiral material of 1 wt. %-20 wt. % comprising at least one chiral center and at least one ethylenic double bond; and
a photo-initiator of 0.05 wt. %-5 wt. %, wherein said first polymeric state selectively reflects a first wavelength, said second polymeric state selectively reflects a second wavelength, and said first wavelength is different from said second wavelength.

12. The multicolor liquid crystal display of claim 11, wherein said tunable chiral polymer further comprises a third polymeric state which selectively reflects a third wavelength which is one of red, green and blue, and said first wavelength, said second wavelength and said third wavelength are mutually different.

13. The multicolor liquid crystal display of claim 11, wherein said tunable chiral polymer is substantially free of a crosslinking agent.

14. The multicolor liquid crystal display of claim 11, further comprising:
a flow channel to accommodate said tunable chiral polymer.
